(19) United States
(12) Patent Application Publication
(10) Pub. No.: US 2023/0125636 A1
(43) Pub. Date: Apr. 27, 2023

(54) USE OF A PHYSICALLY UNCLONABLE FUNCTION TO GENERATE A MEMORY IDENTIFIER

(71) Applicant: Micron Technology, Inc., Boise, ID (US)

(72) Inventor: Lance W. Dover, Fair Oaks, CA (US)

(21) Appl. No.: 17/664,372

(22) Filed: May 20, 2022

Related U.S. Application Data
(60) Provisional application No. 63/262,919, filed on Oct. 22, 2021.

(51) Int. Cl. H04L 9/32; H04L 9/08

(52) U.S. Cl. CPC H04L 9/3278; H04L 9/3263; H04L 9/0825; H04L 9/0866

(57) ABSTRACT

Methods, systems, and devices for use of a physically unclonable function to generate a memory identifier are described. For instance, a memory system may read a set of uninitialized memory cells of a memory system to obtain a first key associated with the memory system. The memory system may generate a private key associated with the memory system based on the first key and may transmit, to a host system, an indication of a public key corresponding to the private key. The memory system may transmit, to the host system, signaling, such as a signature, that is encrypted based on the private key associated with the memory system.

### CROSS REFERENCE

The present application for patent claims the benefit of U.S. Provisional Patent Application No. 63/262,919 by DOVER, entitled “USE OF A PHYSICALLY UNCLONABLE FUNCTION TO GENERATE A MEMORY IDENTIFIER,” filed Oct. 22, 2021, assigned to the assignee hereof, and expressly incorporated by reference herein.

### FIELD OF TECHNOLOGY

The following relates generally to one or more systems for memory and more specifically to the use of a physically unclonable function to generate a memory identifier.

### BACKGROUND

Memory devices are widely used to store information in various electronic devices such as computers, user devices, wireless communication devices, cameras, digital displays, and the like. Information is stored by programming memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read, or sense, the state of one or more memory cells within the memory device. To store information, a component may write, or program, one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be volatile or non-volatile. Volatile memory cells (e.g., DRAM cells) may lose their programmed states over time unless they are periodically refreshed by an external power source. Non-volatile memory cells (e.g., NAND memory cells) may maintain their programmed states for extended periods of time even in the absence of an external power source.

### BRIEF DESCRIPTION OF THE DRAWINGS

FIG. 1 illustrates an example of a system that supports use of a physically unclonable function to generate a memory identifier in accordance with examples as disclosed herein.

FIG. 2 illustrates an example of a system that supports use of a physically unclonable function to generate a memory identifier in accordance with examples as disclosed herein.

FIG. 3 illustrates an example of a security procedure that supports use of a physically unclonable function to generate a memory identifier in accordance with examples as disclosed herein.

FIG. 4 illustrates an example of a process flow that supports use of a physically unclonable function to generate a memory identifier in accordance with examples as disclosed herein.

FIG. 5 illustrates an example of a process flow that supports use of a physically unclonable function to generate a memory identifier in accordance with examples as disclosed herein.

FIG. 6 shows a block diagram of a memory system that supports use of a physically unclonable function to generate a memory identifier in accordance with examples as disclosed herein.

FIG. 7 shows a block diagram of a host system that supports use of a physically unclonable function to generate a memory identifier in accordance with examples as disclosed herein.

FIGS. 8 and 9 show flowcharts illustrating a method or methods that support use of a physically unclonable function to generate a memory identifier in accordance with examples as disclosed herein.

### DETAILED DESCRIPTION

In some examples, a counterfeit memory system may be manufactured that may mimic one or more aspects of a non-counterfeit memory system. Counterfeit memory systems may have a reduced lifespan, density, or performance relative to non-counterfeit memory systems, which may cause reputational or other harms (e.g., to a manufacturer of systems being counterfeited). Additionally or alternatively, counterfeit memory systems may harbor malware or may have unintended or unreliable operation relative to the non-counterfeit memory system. Accordingly, techniques to reliably authenticate and identify a memory device, such as to differentiate a non-counterfeit memory system from a counterfeit memory system, may be beneficial (e.g., due to mitigating one or more of the issues that may arise from undetected counterfeit memory systems, among other possible benefits).

In some examples, a memory system may be identified (e.g., as a non-counterfeit memory system) based on (e.g., due to) a physical unclonable function (PUF) associated with the memory system. For instance, one or more variations that occur during manufacturing may create a set of elements (e.g., SRAM cells) associated with a level of uniqueness as compared to other fabricated devices (e.g., due to the variations that occur during manufacturing from one device to the next, the set of elements in one device may not be completely identical to the corresponding set of elements in any other device, with respect to one or more physical attributes). Accordingly, the set of elements may be used to obtain a unique identifier for the memory system.

For example, a process may be applied to the set of elements to obtain a set of values, and the set of values may be used to generate one or more keys. For example, the set of elements may be a set of uninitialized (not previously written to, at least since a most recent power-on of the memory system) memory cells, and the uninitialized memory cells may be read to obtain a set of logic values. The set of logic values read from the set of uninitialized memory cells may vary from one device to the next (e.g., in random fashion) due to variations in physical attributes of the memory cells across devices, which may be unintended but nevertheless inevitable due to limitations in the precision of an associated manufacturing process. In some cases, a key (e.g., a symmetric key) may be generated based on the read set of logic values, and in some cases the read set of logic values may include some extent of redundancy (e.g., the set of logic value may include a greater quantity of logic values, as represented by bits, than the quantity of bits in the key generated therefrom), such that even if the set of logic values read from the uninitialized memory cells varies from one read event to the next (e.g., from one power-on cycle to the next) for a memory system, an identical key may be obtained based on each read event for the memory system, yet the so-obtained key may be unique relative to that obtained for any other memory system.

In some cases, after generating a key based on the set of elements (e.g., based on the PUF), the memory system may generate a private key based on the key, and then the memory system may generate a public key based on the private key. A host system communicating with the non-counterfeit memory system may determine that the non-counterfeit memory system is not a counterfeit memory system by verifying a signature provided by the memory system, where the signature may be based on (e.g., generated from) the private key. And in some cases, the private key may further be used to generate one or more certificates for the memory system (e.g., certificates endorsed by a trusted certificated authority, which may be or be affiliated with a manufacturer of the memory system), and such a certificate may be used (e.g., by a host system for the memory system) to authenticate the memory system.

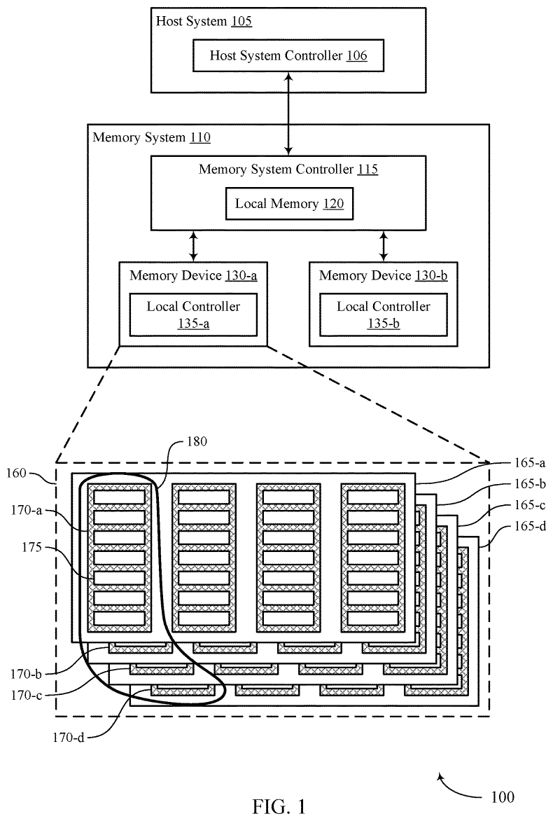

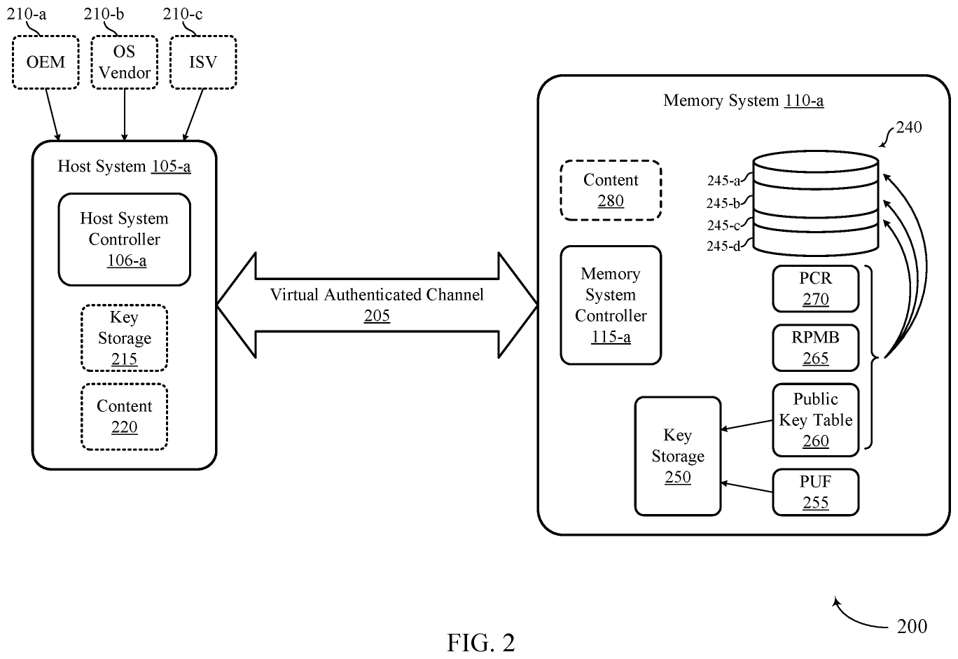

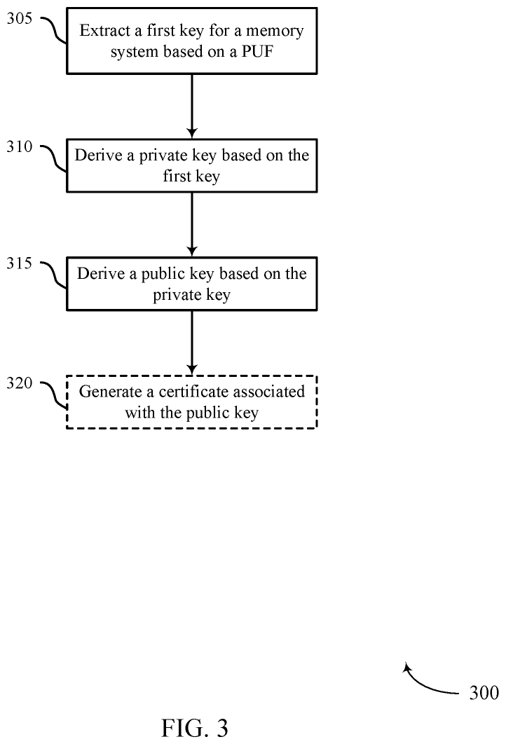

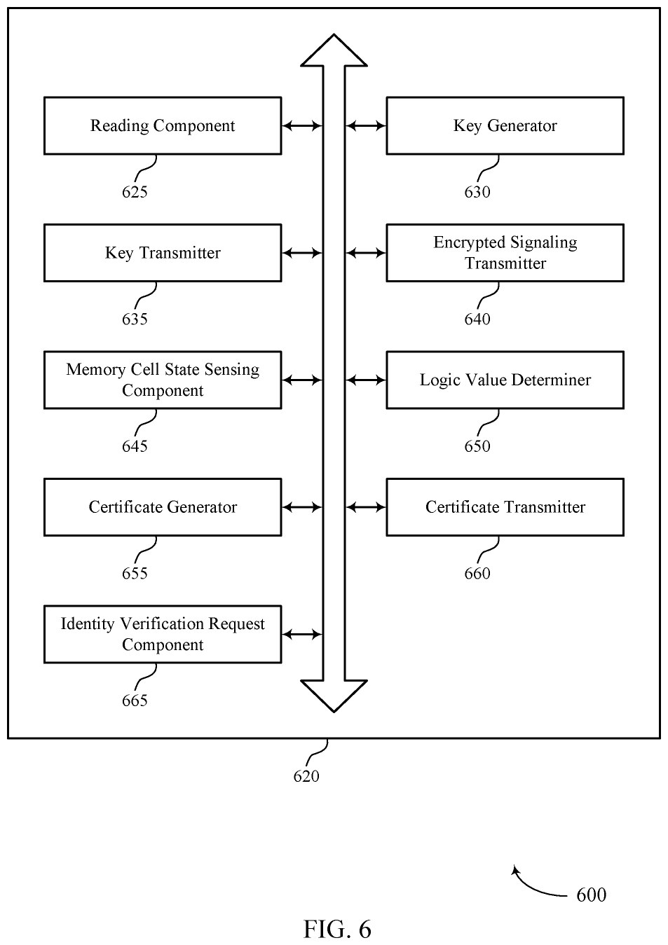

Features of the disclosure are initially described in the context of systems as described with reference to FIGS. 1 and 2. Features of the disclosure are described in the context of a security procedure and process flows with reference to FIGS. 3-5. These and other features of the disclosure are further illustrated by and described in the context of an apparatus diagram and flowchart that relate to use of a physically unclonable function to generate a memory identifier with reference to FIGS. 6-9.

FIG. 1 illustrates an example of a system 100 that supports use of a physically unclonable function to generate a memory identifier in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices, and in some cases may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may in some cases be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally or alternatively include static random access memory (SRAM) or other memory that may be used by the memory system controller 115 for internal storage or calculations, for example, related to the functions ascribed herein to the memory system controller 115. Additionally or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally or alternatively rely upon an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may in some cases instead be performed by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof.

Additionally or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a memory die 160. For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to single level cell (SLC) memory cells but may, in some cases, involve narrower read or write margins or greater complexities for supporting circuitry.

In some cases, planes 165 may refer to groups of blocks 170, and in some cases, concurrent operations may take place within different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165 c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may in some cases not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

The system 100 may include any quantity of non-transitory computer readable media that support use of a physically unclonable function to generate a memory identifier. For example, the host system 105, the memory system controller 115, or a memory device 130 (e.g., a local controller 135) may include or otherwise may access one or more non-transitory computer readable media storing instructions (e.g., firmware) for performing the functions ascribed herein to the host system 105, memory system controller 115, or memory device 130. For example, such instructions, if executed by the host system 105 (e.g., by the host system controller 106), by the memory system controller 115, or by a memory device 130 (e.g., by a local controller 135), may cause the host system 105, memory system controller 115, or memory device 130 to perform one or more associated functions as described herein.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some examples, a counterfeit memory system may be manufactured that may mimic one or more aspects of a non-counterfeit memory system 110. Counterfeit memory systems 110 may have a reduced lifespan, density, or performance relative to non-counterfeit memory systems 110. Additionally or alternatively, counterfeit memory systems 110 may harbor malware or may have unintended or unreliable operation relative to the non-counterfeit memory system 110. Accordingly, techniques that help uniquely identify and authenticate a memory system 110 (e.g., differentiate a non-counterfeit memory system 110 from a counterfeit memory system) may mitigate one or more of the issues that may arise from using a counterfeit memory system, among other possible benefits.

In some examples, memory system 110 may be uniquely identified based on (e.g., due to) a physical unclonable function (PUF) associated with the memory system 110. For instance, one or more variations that occur during manufacturing may create a quantity of redundant elements associated with a level of uniqueness as compared to other fabricated devices (e.g., other memory systems 110 as well as counterfeits thereof). Accordingly, in examples in which a process is applied to the memory system 110 (e.g., reading one or more uninitialized memory cells of the memory system 110, such as SRAM or other types of memory cells included in local memory 120), the process may reproduce a same value each time that may be used to generate a key (e.g., a symmetric key). The memory system 110 may generate a private key using the key and may generate a public key using the private key. A host system 105 communicating with the memory system 110 may determine that the memory system 110 is in fact the memory system 110 (e.g., and not a counterfeit memory system) by verifying a signature that is based on (e.g., generated from) the private key, based on a certificate that is based on (e.g., generated from) the private key, or any combination thereof.

FIG. 2 illustrates an example of a system 200 (e.g., a computer platform) that supports memory system signaling authentication using asymmetric keys in accordance with examples as disclosed herein. The system 200 may include a host system 105-a and a memory system 110-a, which may be examples of the respective systems described with reference to FIG. 1. The host system 105-a and the memory system 110-a may implement various techniques for exchanging public keys to support the communication of signaling between the respective systems with identity authenticity (e.g., signatures) and integrity (e.g., encryption), among other characteristics, which may be based on (e.g., due to) unique and private cryptographic identities of the host system 105-a and the memory system 110-a. The host system 105-a may include a host system controller 106-a and the memory system 110-a may include a memory system controller 115-a, and, in some examples, the host system controller 106-a and the memory system controller 115-a may be configured to perform one or more of the described operations at the host system 105-a and the memory system 110-a, respectively. Although techniques are described with reference a single host system 105-a and a single memory system 110-a of the system 200, the described techniques may be extended to support implementations of a host system 105 that is coupled with any quantity of memory systems 110, or implementations of a memory system 110 that is coupled with any quantity of host systems 105, or implementations of a network of multiple host systems 105 coupled with multiple memory systems 110.

The host system 105-a may be an example of a system that uses at least a portion of the memory system 110-a (e.g., storage 240) for information storage, which may include various operations that support the host system 105-a writing information to the memory system 110-a, or the host system 105-a reading information from the memory system 110-a, or both. In some examples, the host system 105-a may be characterized as being “local,” which may refer to a relatively direct or proximal physical, electrical, or otherwise communicative coupling. In some other examples, the host system 105-a may be characterized as being “remote,” which may refer to a relatively distant (e.g., non-co-located) communicative coupling that may involve one or more wired, wireless, optical, or otherwise relatively distant communicative couplings, such as a cloud application or otherwise distributed compute system.

In some examples, the host system 105-a may include, may be coupled with, or may be otherwise associated with one or more host entities 210. Host entities 210 may be implemented as hardware entities, firmware entities, or software entities, and may include various serial, parallel, or hierarchical coupling or logical organization with or via the host system 105-a. In some examples, the host entities 210 may request or otherwise perform signaling with the memory system 110-a via a common controller or interface (e.g., via host system controller 106-a). In various examples, host entities 210 may be associated with different functions, different feature sets, different permissions, different storage attributes (e.g., data protection attributes), among other different characteristics.

In some examples, each of the host entities 210 may be associated with a unique identifier (e.g., a secret identifier, a unique device secret, a unique entity secret), which may include or may support the generation of a respective private key for the host entity 210. In some examples, an identifier of a host entity 210 may not, itself, be private, but a private key may be generated (e.g., by the host system 105-a) for a host entity 210 based on (e.g., generated from) an identifier (e.g., public or private) of the host entity 210 and a private identifier of the host system 105-a (e.g., a private master identifier). Such techniques may support each of the host entities 210 being uniquely identified and authenticated (e.g., separately from other host entities 210) in accordance with examples as disclosed herein.

The example of host system 105-a may be associated with an original equipment manufacturer (OEM) host entity 210-a, an operating system (OS) vendor host entity 210-b, and an independent software vendor (ISV) host entity 210-c. In some other examples, a host system 105 may include or be otherwise associated with any quantity of one or more host entities 210 including but not limited to one or more OEM host entities 210, OS vendor host entities 210, ISV host entities 210, or other types of host entities. In some examples, host entities 210 may be omitted or otherwise not separately considered, in which case a master private key may be implemented by the host system 105-a (and any host entities 210, where applicable), which may be based on (e.g., due to) a single or shared unique identifier of the host system 105-a (e.g., a secret identifier, a unique device secret, or a unique host secret associated with the host system 105-a).

In some examples, the host system 105-a may be associated with a location for storing authentication or encryption information (e.g., generated or received keys, certificates), such as a key storage 215. For example, the host system 105-a may use the key storage 215 to store one or more private keys or certificates associated with the host system 105-a. In some examples, a key storage 215 may be a portion of the host system 105-a, such as an implementation of a dedicated storage component of the host system 105-a. Additionally or alternatively, one or more components of the key storage 215 may be located outside the host system 105-a, but may be otherwise accessible by the host system 105-a (e.g., in a secure manner). In various examples, the key storage 215 may include a non-volatile storage location (e.g., for static keys or keys maintained for a relatively long time), or a volatile storage location (e.g., for ephemeral keys or keys that are otherwise generated relatively frequently), or both. Although the key storage 215 is illustrated separately from the host system controller 106-a, in some examples, the key storage 215 may be part of or otherwise associated with the host system controller 106-a, such as a storage location that also includes firmware for the host system 105-a or the host system controller 106-a.

In some examples, the host system 105-a may include content 220, which may refer to various types of information stored at the host system 105-a. In some examples, content 220 may be accessed or otherwise used to support various key generation (e.g., content-based key generation) or other cryptographic techniques in accordance with examples as disclosed herein. For example, the content 220 may include firmware of the host system 105-a, such as boot code (e.g., second-stage boot code, “L1” boot code), or a firmware security descriptor (FSD), which may be used to establish an operating or cryptographic state (e.g., a firmware state) of the host system 105-a. In some examples, information associated with the content 220 may be transmitted to the memory system 110-a to support various authentication or encryption techniques (e.g., for the memory system 110-a to generate keys or certificates for operation with the memory system 110-a). Although the content 220 is illustrated separately from the host system controller 106-a, in some examples, the content 220 may be part of or otherwise associated with the host system controller 106-a, such as a storage location that includes firmware for the host system 105-a or the host system controller 106-a.

The memory system 110-a may include storage 240, which may refer to a collective storage capacity of one or more instances of local memory 120, or of one or more memory devices 130, or various combinations thereof that are included in or are otherwise associated with the memory system 110-a. In some examples, the storage 240 may be divided or otherwise organized in partitions 245 (e.g., memory ranges, address ranges), which may refer to various subsets or ranges of logical addresses or physical addresses of the associated local memory 120 or memory devices 130. In some examples, the partitions 245 may be assigned with an initial range of addresses, and may be updated with an assignment to a different range of addresses, including an appending of additional new addresses, an assignment to a subset of the initial range of addresses (e.g., a trimming of ranges), or an assignment to an entirely new range of addresses.

In some examples, partitions 245, or portions thereof, may be assigned to or allocated to different functions or attributes, such as examples where one or more partitions 245 are associated with a respective one or more host entities 210, or their respective public or private keys. In an example implementation, a partition 245-a may be associated with the OEM host entity 210-c, a partition 245-b may be associated with the OS vendor host entity 210-b, and a partition 245-c may be associated with the ISV host entity 210-c. In some examples, a partition 245-d may be unallocated (e.g., not dedicated to a certain purpose or entity, free space), or may be shared among multiple host entities 210, among other examples for allocating partitions 245. In some examples, partitions 245 may be used to implement various hierarchical keying or authentication techniques. For example, each partition 245, or some portion of a partition 245, may be assigned with or updated with a protection attribute (e.g., enabling or disabling a write protection attribute, enabling or disabling a read protection attribute), which may be associated with various keys, authentications, or encryptions that are specific to a given host entity 210, or that are common to the host system 105-a in general, among other examples.

In some examples, the memory system 110-a may be associated with a location for storing authentication or encryption information (e.g., generated or received keys, certificates), such as a key storage 250. For example, the memory system 110-a may use the key storage 250 to store one or more private keys associated with the memory system 110-a, or one or more public keys or certificates generated by the memory system 110-a, or one or more public keys or certificates received from the host system 105-a (or other host systems 105, not shown). In some examples, the key storage 250 may be a portion of the memory system 110-a, such as an implementation of a dedicated storage component of the memory system 110-a. Additionally or alternatively, the key storage 250 may be located outside the memory system 110-a, but may be otherwise accessible by the memory system 110-a (e.g., in a secure manner). In various examples, the key storage 250 may include a non-volatile storage location (e.g., for static keys or keys maintained for a relatively long time), or a volatile storage location (e.g., for ephemeral keys or keys that are otherwise generated relatively frequently), or both. Although the key storage 250 is illustrated separately from the storage 240, the key storage 250 may, in some examples, be included in a portion of the storage 240 (e.g., in a separate or dedicated partition 245). Further, although the key storage 250 is illustrated separately from the memory system controller 115-a, in some examples, the key storage 250 may be part of or otherwise associated with the memory system controller 115-a, such as a storage location that also includes firmware for the memory system 110-a or the memory system controller 115-a (e.g., a local memory 120).

In some examples, the memory system 110-a may include a physical unclonable function (PUF) 255, which may support the assignment of or generation of an identifier that is unique to the memory system 110-a (e.g., for generating a secret identifier or a unique device secret of the memory system 110-a). The PUF 255 may include various components or circuit elements that have an intrinsic physical characteristic that is unique to the PUF 255, which may be leveraged to establish an intrinsic uniqueness of the memory system 110-a. For example, the PUF may include a set of one or more transistors, resistors, capacitors, memory cells (e.g., SRAM cells, which may, in some cases, be included in local memory 120 described with reference to FIG. 1), or other circuit elements or combination thereof which, in examples in which these circuits elements are accessed, support the generation of a digital signature that is unique to the memory system 110-a. In some examples, a controller of the memory system 110-a (e.g., the memory system controller 115-a) may access or otherwise interact with the PUF 255 to generate one or more private keys for the memory system 110-a, which may subsequently be used to generate public keys for establishing authenticity or encryption between the memory system 110-a and the host system 105-a (e.g., or the host entities 210, where applicable). Although the PUF 255 is illustrated as being separate from the key storage 250, in some examples, the PUF 255 may be included in or be otherwise interpreted as being part of the key storage 250 (e.g., part of the memory system controller 115-a, part of a local memory 120 of the memory system 110-a).

In various implementations, the PUF 255 itself, or signaling generated by the PUF 255, or both may be inaccessible from outside the memory system 110-a. Such inaccessibility may be supported by various implementations of including the PUF 255, and other components involved in the described cryptographic techniques, in a portion of the memory system 110-a where attempts to access such components would be destructive to the components, or where such components or associated signaling are otherwise shielded from destructive or non-destructive probing or snooping techniques. For example, at least the PUF 255 and the other components involved in the described cryptographic techniques (e.g., components involved in handling private keys or unique device secrets, which may include at least a portion of the memory system controller 115-a or at least some portion thereof), if not all the components of the memory system 110-a, may be implemented in a contiguous semiconductor chip such as an SoC implementation.

In some examples, the memory system 110-a may include a public key table 260 (e.g., an elliptical curve cryptography public key table), which may be configured to store, organize, or allocate public keys such as those received from the host system 105-a, or those generated at the memory system 110-a, or both. In some examples (e.g., in implementations where host entities 210 are associated with respective public keys that are transmitted by the host system 105-a), the public key table 260 may hold a respective public key, or mapping thereof, for each of the OEM host entity 210-a, the OS vendor host entity 210-b, and the ISV host entity 210-c (e.g., associated with the partitions 245-a, 245-b, and 245-c, respectively). Although the public key table 260 is illustrated as being separate from the key storage 250, in some examples, the public key table 260 may be included in or be otherwise interpreted as being part of the key storage 250 (e.g., part of the memory system controller 115-a, part of a local memory 120 of the memory system 110-a).

In some implementations, the public key table 260 may be associated with a mapping between public keys and device identifiers, or partitions 245, or protection attributes (e.g., write protection configurations, read protection configurations), or various combinations thereof, among other mapping between keys and associated configurations. For example, the public key table 260 may provide a mapping for one or more host systems 105 (e.g., the host system 105-a), or a host entity 210 thereof, with a particular public key or symmetric key. Such a mapping may also include a mapping between such keys and one or more partitions 245, or a mapping between such keys or partitions 245 with one or more protection attributes, such as whether a partition 245 is configured with read protection, write protection, or both. In some examples, a mapping of the public key table 260 may include a mapping of a key, a host system 105, or a host entity 210 with multiple partitions 245, which may support each partition 245 using a common key but having a unique protection attribute. In some examples, the public key table may support a key hierarchy that allows a master host system 105, or associated key, to assign partitions 245 to another host system 105 or to a host entity 210, or their respective keys.

In some examples, the memory system 110-a may include a platform configuration register (PCR) 270, which may store or measure a software state (e.g., version, update status), such as a state of software running on the memory system 110-a, and configuration data used by such software (e.g., to represent the platform software state of the memory system 110-a). In some examples, the PCR 270 may include information that can be evaluated to determine whether the memory system 110-a has been compromised or may be otherwise untrustworthy. Although the PCR 270 is illustrated separately from the memory system controller 115-a, in some examples, the PCR 270 may be part of or otherwise associated with the memory system controller 115-a, such as a location associated with firmware for the memory system 110-a or the memory system controller 115-a (e.g., a local memory 120). Such techniques may support the PCR 270 storing or measuring a state of such firmware, which may be used to evaluate whether such firmware has been adversely updated (e.g., to evaluate whether the memory system 110-a can be authenticated).

In some examples, the memory system 110-a may include a replay-protected memory block (RPMB) 265, which may be provided as a means to store data in an authenticated and replay protected manner, which may only be read and written via successfully authenticated read and write accesses. In some examples, the RPMB 265 may include information that can be evaluated to determine whether signaling exchanged with the memory system 110-a has been intercepted and replayed, which may indicate whether one or more devices or connections of the system 200 are untrustworthy. Although the RPMB 265 is illustrated separately from the memory system controller 115-a, in some examples, the RPMB 265 may be part of or otherwise associated with the memory system controller 115-a, such as a storage location that includes firmware for the memory system 110-a or the memory system controller 115-a (e.g., a local memory 120). In some examples, the RPMB 265 may be associated with a fixed size, a fixed set of addresses, or both.

In some examples, the memory system 110-a may include content 280, which may refer to various types of information stored at the memory system 110-a. In some examples, content 280 may be accessed or otherwise used to support various key generation (e.g., content-based key generation) or other cryptographic techniques in accordance with examples as disclosed herein. For example, the content 280 may include firmware of the memory system 110-a, such as boot code (e.g., first-stage boot code, “L0” boot code, second-stage boot code, “L1” boot code), or an FSD, which may establish an operating or cryptographic state of the memory system 110-a. In some examples, information associated with the content 280 may be used by the memory system 110-a to support various authentication or encryption techniques (e.g., to generate a certificate for operation with the host system 105-a). Although the content 280 is illustrated separately from the memory system controller 115-a, in some examples, the content 280 may be part of or otherwise associated with the memory system controller 115-a, such as a storage location that includes firmware for the memory system 110-a or the memory system controller 115-a. Further, although the content 280 is illustrated separately from the storage 240, the content 280 may, in some examples, refer to information that is included in a portion of the storage 240 (e.g., in a separate or dedicated partition 245). In some implementations, the content 280 may receive information from or may refer to one or more aspects of the PCR 270.

One or more components of the system 200 may be configured to implement asymmetric key distribution to establish authenticated signaling, encrypted signaling, or both between the host system 105-a and the memory system 110-a (e.g., in accordance with authenticated system identity), which may include an implementation of cryptographic security functionality directly in the memory system 110-a (e.g., leveraging capabilities of the memory system controller 115-a to support various techniques for asymmetric cryptography). In some examples, such techniques may involve passing fundamentally public device identification information between the host system 105-a and the memory system 110-a that supports private authentication of the respective system (e.g., device-specific or hardware-specific authentication without trying to maintain secrecy or avoid exposure of exchanged private or secret keying material corresponding to respective devices). In some examples, such asymmetric cryptography may be utilized to derive equivalent or otherwise symmetric keys on each side of signaling exchange (e.g., at each of the host system 105-a and the memory system 110-a) using a common secret that is not itself communicated between the host system 105-a and the memory system 110-a, which may leverage efficiencies of symmetric key techniques for authenticated or encrypted signaling relative to asymmetric key techniques. In some examples, such techniques may be implemented to establish a virtual authenticated channel 205 between the host system 105-a and the memory system 110-a, which may be used to transmit signaling (e.g., encrypted signaling, unencrypted signaling) and associated signatures (e.g., asymmetric signatures such as elliptic curve digital signature algorithm (ECDSA) signatures, symmetric signatures such as hashed message authentication code (HMAC) signatures) between the host system 105-a and the memory system 110-a.

In some examples, the system 200 may be configured to support a signing and verifying (e.g., authentication) of signaling between the host system 105-a and the memory system 110-a (e.g., in accordance with signed command signaling, signed request signaling, signed data signaling, or signed response signaling), which may be implemented to authenticate the transmitting system of such signaling, or to ensure that the signaling has not been altered before being received by a receiving system, or both. In accordance with such techniques, a receiving system may be able to evaluate received signaling to determine whether transmitted signaling was transmitted by an unverified or unauthorized transmitting system, or whether the transmitted signaling was altered or otherwise compromised. In some examples, such techniques may support a one-to-many security arrangement, since multiple receiving systems may be able to implement a same public key (e.g., of an asymmetric key pair) of the transmitting system that is associated with a single private key (e.g., of the asymmetric key pair) of the transmitting system.

In some examples for signing and verifying signaling between the host system 105-a and the memory system 110-a, a signature for a given instance of signaling (e.g., a message, a command, a request, a data packet, a response) may be derived by hashing or otherwise processing the instance of signaling with a function (e.g., a hash function, a cryptographic hash algorithm) that receives, as an input, the instance of signaling and a private key associated with the transmitting system. The output of such a function (e.g., a signature, a hash digest) may be recreated using the same function with the same instance of signaling and either the same private key associated with the transmitting system or an associated public key (e.g., of an asymmetric key pair) associated with the transmitting system. In an example, for an instance of signaling associated with a 1-megabyte program operation, a hashing function based on (e.g., generated from) the 1-megabytes of data and a private key may be a 256-bit signature or hash digest.

To support verifying the authenticity of the transmitting system, the transmitting system may transmit the instance of signaling along with the corresponding signature, which may be received by a receiving system. The receiving system may have received or otherwise generated the associated public key of the transmitting system and, accordingly, may generate a trial signature based on (e.g., derived from) the received instance of signaling and the associated public key of the transmitting system. If the trial signature matches the received signature, the receiving system may determine that the transmitting system was authentic (e.g., that the instance of signaling is a transmission from a trusted system) and may continue with processing or otherwise performing a responsive action to the received instance of signaling. In some implementations, signature generation may be configured such that, even in examples in which an instance of signaling is the same, a generated signature will be different. In such implementations, signature generation and verification operations may be further based on (e.g., using) a random value, a nonce, or a monotonic counter that is understood to both the transmitting system and the receiving system.

In some examples, the system 200 may be configured to support an encryption and decryption of signaling between the host system 105-a and the memory system 110-a (e.g., in accordance with encrypted signatures, encrypted command signaling, encrypted request signaling, encrypted data signaling, or encrypted response), which may be implemented to secure the contents of such signaling from being intercepted and interpreted or otherwise processed (e.g., to maintain integrity of the signaling itself). In accordance with such techniques, a transmitting system may encrypt instances of signaling for transmission using a key (e.g., of a symmetric key pair) known to the transmitting system, and a receiving system may decrypt received instances of such signaling using a key known to the receiving system (e.g., of the same symmetric key pair), which may be the same as the symmetric key known to the transmitting system, or may be otherwise equivalent or operable for such decryption. In some examples, such techniques may support a one-to-one security arrangement, since a symmetric key pair may only be understood to a single transmitting system and a single receiving system (e.g., in examples in which a symmetric key pair is based on (e.g., generated from) unique identifiers of each of the transmitting system and the receiving system). However, some cryptographic techniques may support arrangements other than a one-to-one security arrangement, such as in examples in which symmetric keys are based on (e.g., generated from) unique identifiers of more than two systems.

Some implementations of the described techniques may utilize asymmetric cryptography where a public key associated with the host system 105-a may be uploaded to one or more memory systems 110 (e.g., the memory system 110-a) without exposing a private key of the host system 105-a, which may prevent an adverse actor from stealing the key and impersonating the real key holder (e.g., impersonating the host system 105-a). Such techniques may also allow a public key to be replaced, which may be different than other techniques such as those related to a RPMB or a replay-protection monotonic counter (RPMC). In some examples, such asymmetric cryptography techniques may facilitate the use of public key infrastructure (PKI) techniques, where keys may be verified through a standardized digital certificate chain.

In some implementations, the exchange of public keys may support the generation of symmetric keys at each of the host system 105-a and the memory system 110-a using such techniques as a Diffie-Hellman key exchange or elliptic-curve techniques, so that a symmetric secret can be shared between device and host without exposing the private keys of the respective systems. In some implementations, an asymmetric Diffie-Hellman key exchange can be performed between the host system 105-a and the memory system 110-a to generate symmetric keys that are then used to enable better performance at the host system 105-a or the memory system 110-a for authentication, encryption, or both. Further, ephemeral symmetric keys can be derived using a same algorithm shared by the host system 105-a and the memory system 110-a to make it more difficult for an adverse actor to extract or replicate such keys, based on (e.g., using) various techniques for duration-initiated or event-initiated generation of ephemeral keys.

In some examples, the exchange of public keys may be associated with the creation of digital certificates, which may include various signaling with or other interaction with one or more certificate authorities or registration authorities, or may involve self-signed certificates, or various combinations thereof. For example, the host system 105-a, or a cloud authority or other centralized certification authority in communication with the host system 105-a, may create a certificate signing request (CSR), which may be an example of a self-signed certificate that proves that memory system 110-a has the private key associated with the public key in the CSR. In some examples, such a CSR may be transferred from the memory system 110-a to a centralized certification authority as part of a manufacturing operation (e.g., for manufacturing the memory system 110-a). In some implementations, in response to an identity of the memory system 110-a being confirmed (e.g., by a cloud authority), a manufacturer-endorsed certificate may be provided to the host system 105-a, to the memory system 110-a, or to both. In some examples, such techniques may support a requesting system downloading a manufacturer-endorsed certificate (e.g., a certificate endorsed by a certificate authority) or downloading the CSR.

FIG. 3 illustrates an example of a security procedure 300 that supports use of a physically unclonable function to generate a memory identifier in accordance with examples as disclosed herein. In some examples, security procedure 300 may be implemented by one or more aspects of a system 100 or 200 as described herein. For instance, security procedure 300 may be implemented by a memory system 110 as described with reference to FIG. 1 or a memory system 110-a as described with reference to FIG. 2. Aspects of the security procedure 300 may be implemented by a controller, among other components. Additionally or alternatively, aspects of the security procedure 300 may be implemented as instructions stored in memory (e.g., firmware stored in a memory coupled with a memory controller). For example, the instructions, in examples in which the instructions are executed by a controller (e.g., the memory controller), may cause the controller to perform the operations of the security procedure 300.

At 305, a first key may be extracted based on (e.g., be extracted from) a PUF, which may be an example of a PUF 255 as described with reference to FIG. 2. For instance, a memory system may extract a first key (e.g., a symmetric key) for the memory system based on a PUF. For instance, the memory system may read a set of uninitialized memory cells (e.g., SRAM memory cells) of the memory system (e.g., of a local memory 120) to obtain a set of logic values (e.g., bits). In some examples, reading the set of uninitialized memory cells to obtain the set of logic values includes sensing, for each memory cell of the set of uninitialized memory cells, a respective uninitialized state of the memory cell and determining, for each memory cell of the set of uninitialized memory cells, a respective logic value corresponding to the respective uninitialized state of the memory cell.

The logic values sensed for a particular uninitialized memory cell may be dependent on one or more physical attributes of the memory cell (e.g., one or more physical dimensions or material properties), which may inevitably vary form one memory cell to another due to unintended but inevitable variations (e.g., imperfections) associated with manufacturing the memory cells (e.g., no two memory cells may be completely identical, similar to how no two snowflake may be completely identical). Each uninitialized memory cell may tend to resolve to a particular logic value when sensed while in an uninitialized state (e.g., some memory cells may tend to resolve to a state associated with a logic 1, while other memory cells may tend to resolve to a state associated with a logic 0). As used herein, an uninitialized memory cell may refer to a memory cell whose state does not depend on a prior write or program operation, such as a memory cell that has never been deterministically written, or a volatile memory cell that has not been deterministically written since a most recent power-off of the memory system. Hence, a memory cell whose state is independent of any prior intentional writing of the memory cell to be in a particular state may be considered an uninitialized memory cell.

In some cases, the logic values obtained directly from the PUF may be considered the first key. Alternatively, obtaining the first key may include generating the first key based on (e.g., derived from) a redundancy associated with the set of logic values obtained directly from the PUF, where the set of logic values include a greater quantity of bits than the first key. For example, the PUF may include a relatively large quantity of redundant elements (e.g., a relatively large quantity of uninitialized SRAM cells), such that the set of logic values includes a relatively large quantity of logic values, corresponding to a relatively large quantity of bits. A parity-based scheme (e.g., based on parity checks, XOR operations, or any combination thereof) may be used to obtain the first key such that variations of individual logic values within the set of logic values from one read event to the next do not alter the associated first key, and an identical set of bits is included in the first key each time the first key is generated. For example, each bit within the first key may have a value based on multiple logic values within the set of logic values, each bit within the first key may have a consistent value even if one or more logic values within the set of logic values fluctuates from one reading of the set of uninitialized memory cells to the next (e.g., due to operating temperature, electromagnetic interference, or other spurious or random factors).

At 310, a private key may be generated based on (e.g., derived from) the first key. For instance, the memory system may generate (e.g., derive) a private key associated with the memory system based on (e.g., derived from) the first key. For example, the memory system may generate the private key based on the first key using an elliptic curve algorithm, such as an elliptic curve digital signature (ECDSA) algorithm. In some cases, the private key may be the same as the first key, or the private key may be generated by the memory system based on inputting the first key into a hashing or other cryptographic algorithm.

Beneficially, the first key, and the logic values obtained from the PUF if different from the first key, need not be stored at the memory system when the memory system after the private key is generated at 310. Additionally or alternative, first key, and the logic values obtained from the PUF if different from the first key, need not be stored at the memory system when the memory system in a power-off state. That is, the set of logic values and the first key may be obtained upon power-up or some other event but may otherwise not be stored at the memory system, including when the memory system is powered off. This may beneficially prevent snooping of the set of logic values and the first key by malicious actors.

At 315, a public key may be generated based on (e.g., derived from) the private key. the memory system may generate (e.g., derive) a public key associated with the memory system based on (e.g., derived from) the private key. In some examples, the memory system may transmit, to a host system for the memory system, an indication of a public key corresponding to the private key. For example, the memory system may generate the public key based on the private key using an elliptic curve algorithm, such as an ECDSA algorithm.

At 320, a certificate associated with (e.g., based on) the public key may be generated. For instance, the memory system may generate a certificate associated with the memory system based on (e.g., derived from) the public key and may output an indication of the certificate to a device external to the memory system (e.g., a certificate authority, a host system). In other examples, the memory system may transmit the public key generated at 315 to a certificate authority, and the certificate authority may generate the certificate (e.g., based on the public key). The certificate may, as one example, be an x.509 certificate. In some cases the certificate may include the public key generated at 315, a unique identifier (UID) for the memory system, or any combination thereof—e.g., the public key generated at 315, the UID for the memory system, or any combination thereof may be included in or otherwise derivable from the certificate. The certificate may support subsequent verification of the identity of the memory system, such as using related techniques described herein.

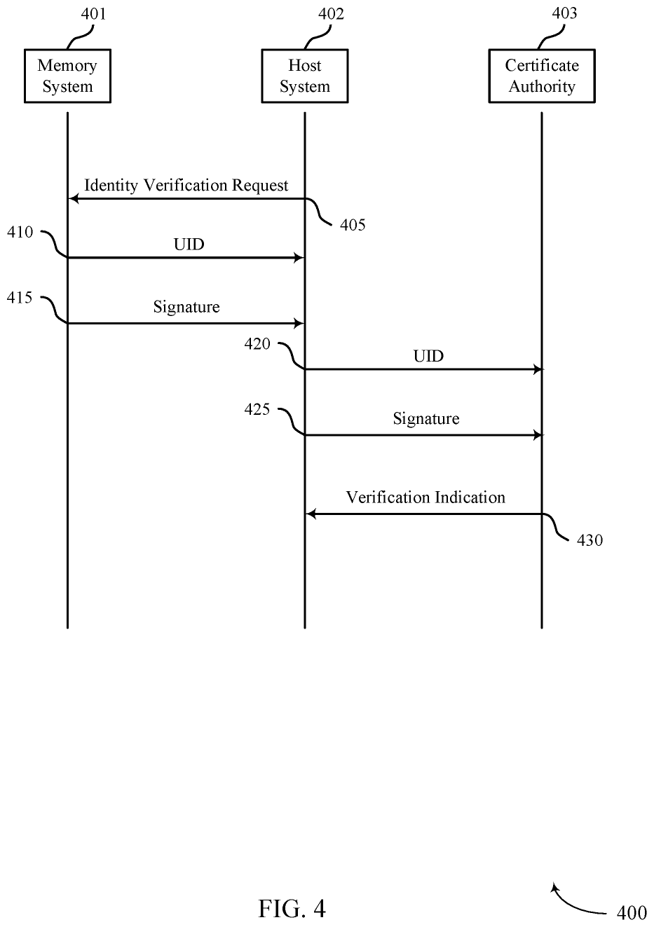

FIG. 4 illustrates an example of a process flow 400 that supports use of a physically unclonable function to generate a memory identifier in accordance with examples as disclosed herein. In some examples, process flow 400 may be implemented by one or more aspects of systems 100 or 200. For instance, memory system 401 may be an example of a memory system 110 as described with reference to FIG. 1 or a memory system 110-a as described with reference to FIG. 2. Additionally or alternatively, host system 402 may be an example of a host system 105 as described with reference to FIG. 1 or a host system 105-a as described with reference to FIG. 2. Aspects of the process flow 400 may be implemented by a controller, among other components. Additionally or alternatively, aspects of the process flow 400 may be implemented as instructions stored in memory (e.g., firmware stored in a memory coupled with a memory controller, a controller for a host system, a controller for a certificate authority). For example, the instructions, in examples in which the instructions are executed by a controller (e.g., the memory controller, the controller for the host system, the controller for the certificate authority), may cause the controller to perform the operations of the process flow 400.

At 405, an identity verification request may be transmitted. For instance, host system 402 may transmit an identity verification request to memory system 401. In some examples, host system 402 may generate the identity verification request based on (e.g., using or including) a nonce (e.g., a random number). Host system 402 may receive an indication of the nonce from a certificate authority associated with the memory system.

At 410, a UID may be transmitted. For instance, memory system 401 may transmit a UID for the memory system to host system 402. The UID may be any unique identifier (e.g., numeric sequence) for the memory system 401.

At 415, a signature may be transmitted. For instance, memory system 401 may transmit a signature to host system 402. In some such examples, the signature may be based on the nonce. Additionally or alternatively, the signature may be based on a private key associated with memory system 401, where the private is key is based on a PUF for memory system 401 as described herein. The signature may be an encrypted portion of a message, such as an encryption of the nonce where the encryption is based on the private key.

After receiving the UID and signature, host system 402 may verify the signature based on a public key corresponding to the private key associated with memory system 401. For instance, at 420, a UID may be transmitted to certificate authority 403. For instance, host system 402 may transmit the UID for memory system 401 to a certificate authority 403 associated with memory system 401. Additionally, at 425, a signature may be transmitted to certificate authority 403. For instance, host system 402 may transmit the signature to certificate authority 403. Certificate authority 403 may be a trusted certificate authority and may, in some cases, be affiliated with the manufacturer of memory system 401. Certificate authority 403 may be in communication with host system 402, such as through an internet connection, for example.

At 430, an indication may be received from certificate authority 403 of whether the UID corresponds to the signature. For instance, host system 402 may receive an indication from certificate authority 403 of whether the UID corresponds to the signature, where the indication from certificate authority 403 is based on the public key (e.g., the certificate authority 403 may use the public key associated with the memory system—such as associated with the UID—to verify the signature). If the signature is successfully verified based on the public key obtained at 525, then host system 502 may determine that memory system 501 (e.g., the memory system from which the signature was received at 540) is the memory system corresponding to the certificate received at 515, and hence really is the memory system having the UID received at 535.

In some examples, host system 402 may receive a CSR based on verifying the signature. A CSR may be created by certificate authority 403 in response to a positive memory device identity verification. A CSR, in some examples, may be a self-signed certificate that indicates that the generator (e.g., memory system 401, which may have generated the certificate at an earlier time and transferred the certificate to certificate authority 403) has the private key associated with the public key in the CSR. Hence, in some examples, the CSR may come directly from the private key holder (e.g., memory system 401). However, in other examples, the CSR may be transferred from the memory system 401 to the certificate authority 403 (e.g., cloud service), such as part of a prior manufacturing flow. Accordingly, in examples in which the memory system 401 identity is confirmed by certificate authority 403, certificate authority 403 may offer host system 402 the ability to download a manufacturer-endorsed certificate or the CSR. The CSR may enable host system 402 to subsequently create a certificate endorsed by a device (e.g., a party) selected by host system 402.

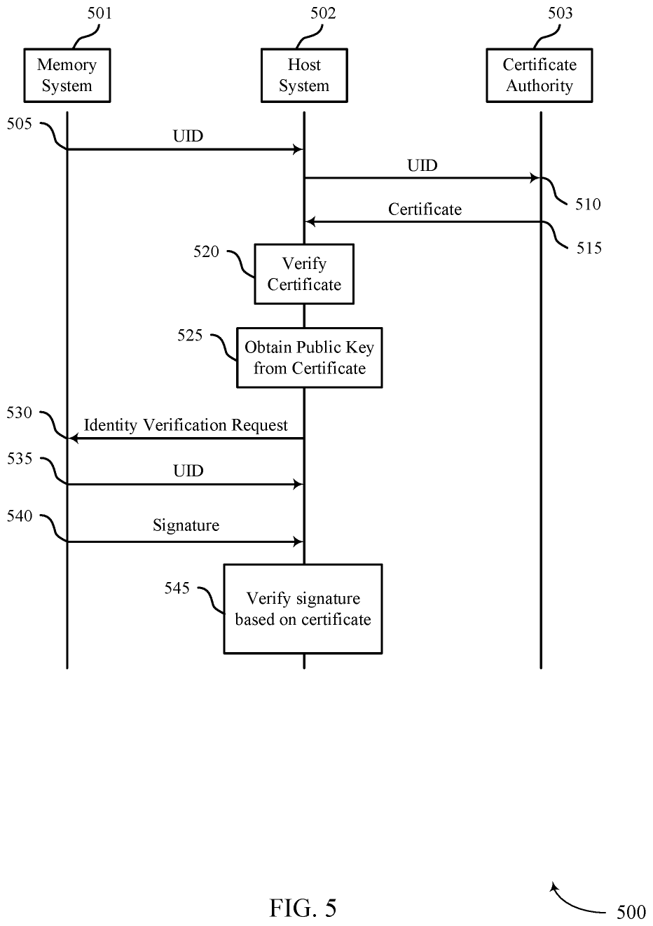

FIG. 5 illustrates an example of a process flow 500 that supports use of a physically unclonable function to generate a memory identifier in accordance with examples as disclosed herein. In some examples, process flow 500 may be implemented by one or more aspects of systems 100 or 200. For instance, memory system 501 may be an example of a memory system 110 as described with reference to FIG. 1 or a memory system 110-a as described with reference to FIG. 2. Additionally or alternatively, host system 502 may be an example of a host system 105 as described with reference to FIG. 1 or a host system 105-a as described with reference to FIG. 2. Additionally or alternatively, aspects of the process flow 500 may be implemented as instructions stored in memory (e.g., firmware stored in a memory coupled with a memory controller, a controller for a host system, a controller for a certificate authority). For example, the instructions, in examples in which the instructions are executed by a controller (e.g., the memory controller, the controller for the host system, the controller for the certificate authority), may cause the controller to perform the operations of the process flow 500.

At 505, a UID may be transmitted. For instance, memory system 501 may transmit a UID for the memory system 501 to host system 502. The UID may be any unique identifier (e.g., numeric sequence) for the memory system 501. In some cases, the UID may be transmitted at 505 in response to a UID request (not shown) transmitted from host system 502 to memory system 501.

At 510, a UID may be transmitted to certificate authority 503. For instance, host system 502 may transmit the UID for memory system 501 to a certificate authority 503 associated with memory system 501. Certificate authority 503 may be a trusted certificate authority and may, in some cases, be affiliated with the manufacturer of memory system 501. Certificate authority 503 may be in communication with host system 502, such as through an internet connection, for example.

At 515, a certificate may be received by host system 502. The certificate may be for a memory system corresponding to the UID received by certificate authority at 510. For instance, certificate authority 503 may transmit the certificate to host system 502. The certificate may be a certificate as described with reference to 320 of FIG. 3 and may be based on a PUF of memory system 501 (e.g., based on keys derived directly or indirectly from the PUF).

At 520, the certificate may be verified by host system 502. For example, host system 502 may verify a signature associated with the certificate (e.g., a signature of the certificate authority 503) to confirm authenticity or trustworthiness of the certificate.

At 525, host system 502 may obtain a public key from the certificate, where the public key is of a memory system associated with the certificate. For example, the public key may be included in the certificate (e.g., as a field within the certificate) or otherwise derivable from the certificate.

At 530, an identity verification request may be transmitted. For instance, host system 502 may transmit an identity verification request to memory system 501. In some examples, host system 502 may generate the identity verification request based on (e.g., using or including) a nonce (e.g., a random number). At the time the identity verification request is transmitted, host system 502 may lack a communications link with certificate authority 503. Thus, for example, process flow 500 may support verification of the identify of memory system 501 even when host system 502 is unable to communicate with certificate authority 503 (e.g., when host system 502 is “offline.”)

At 535, a UID may be transmitted. For instance, memory system 501 may transmit a UID for the memory system to host system 502. The host system 502 may verify whether the UID is the same UID transmitted at 505 and 510. Additionally or alternatively, host system 535 may obtain (e.g., derive) a UID from the certificate verified at 520, and host system 502 may verify whether the UID received at 535 matches the UID obtained from the certificate.

At 540, a signature may be transmitted. For instance, memory system 501 may transmit a signature to host system 502. In some such examples, the signature may be based on the nonce. Additionally or alternatively, the signature may be based on a private key associated with memory system 501, where the private is key is based on a PUF for memory system 501 as described herein. The signature may be an encrypted portion of a message, such as an encryption of the nonce where the encryption is based on the private key.

At 545, the signature may be verified. For instance, host system 502 may verify the signature based on the public key obtained at 525. If the signature is successfully verified based on the public key obtained at 525, then host system 502 may determine that memory system 501 (e.g., the memory system from which the signature was received at 540) is the memory system corresponding to the certificate received at 515, and hence really is the memory system having the UID received at 535.

FIG. 6 shows a block diagram 600 of a memory system 620 that supports use of a physically unclonable function to generate a memory identifier in accordance with examples as disclosed herein. The memory system 620 may be an example of aspects of a memory system as described with reference to FIGS. 1 through 5. The memory system 620, or various components thereof, may be an example of means for performing various aspects of use of a physically unclonable function to generate a memory identifier as described herein. For example, the memory system 620 may include a reading component 625, a key generator 630, a key transmitter 635, an encrypted signaling transmitter 640, a memory cell state sensing component 645, a logic value determiner 650, a certificate generator 655, a certificate transmitter 660, an identity verification request component 665, or any combination thereof. Each of these components may communicate, directly or indirectly, with one another (e.g., via one or more buses).

The reading component 625 may be configured as or otherwise support a means for reading a set of uninitialized memory cells of a memory system to obtain a first key associated with the memory system. The key generator 630 may be configured as or otherwise support a means for generating a private key associated with the memory system based at least in part on the first key. The key transmitter 635 may be configured as or otherwise support a means for transmitting, to a host system for the memory system, an indication of a public key corresponding to the private key. The encrypted signaling transmitter 640 may be configured as or otherwise support a means for transmitting, to the host system, signaling that is encrypted based at least in part on the private key associated with the memory system.

In some examples, to support reading the set of uninitialized memory cells to obtain the first key, the memory cell state sensing component 645 may be configured as or otherwise support a means for sensing, for each memory cell of the set of uninitialized memory cells, a respective uninitialized state of the memory cell. In some examples, to support reading the set of uninitialized memory cells to obtain the first key, the logic value determiner 650 may be configured as or otherwise support a means for determining, for each memory cell of the set of uninitialized memory cells, a respective logic value corresponding to the respective uninitialized state of the memory cell, where the first key is based at least in part on a set of logic values that includes the respective logic value for each memory cell of the set of uninitialized memory cells.

In some examples, to support reading the set of uninitialized memory cells to obtain the first key, the key generator 630 may be configured as or otherwise support a means for generating the first key based at least in part on a redundancy associated with the set of logic values, where the set of logic values includes a greater quantity of bits than the first key.

In some examples, the respective uninitialized state that is sensed for a memory cell of the set of uninitialized memory cells is based at least in part on one or more physical characteristics of the memory cell.

In some examples, the one or more physical characteristics of the memory cell are based at least in part on one or more variations in a fabrication process for the memory cell.

In some examples, a set of uninitialized states for the set of uninitialized memory cells includes a physical unclonable function for the memory system, the set of uninitialized states including the respective uninitialized state for each memory cell of the set of uninitialized memory cells.

In some examples, the certificate generator 655 may be configured as or otherwise support a means for generating a certificate associated with the memory system based at least in part on the public key. In some examples, the certificate transmitter 660 may be configured as or otherwise support a means for outputting an indication of the certificate to a device external to the memory system.

In some examples, the identity verification request component 665 may be configured as or otherwise support a means for receiving, from the host system, an identity verification request. In some examples, the identity verification request component 665 may be configured as or otherwise support a means for transmitting, to the host system in response to the identity verification request, a unique identifier for the memory system and a signature based at least in part on the private key.

In some examples, the key generator 630 may be configured as or otherwise support a means for generating the public key based at least in part on the private key.

In some examples, the first key includes a symmetric key.

In some examples, the set of uninitialized memory cells includes a set of static random-access memory cells.

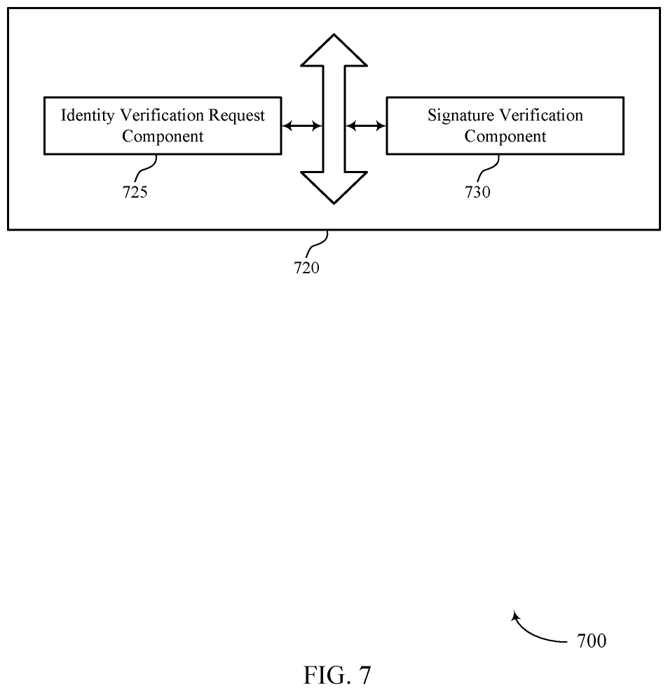

FIG. 7 shows a block diagram 700 of a host system 720 that supports use of a physically unclonable function to generate a memory identifier in accordance with examples as disclosed herein. The host system 720 may be an example of aspects of a host system as described with reference to FIGS. 1 through 5. The host system 720, or various components thereof, may be an example of means for performing various aspects of use of a physically unclonable function to generate a memory identifier as described herein. For example, the host system 720 may include an identity verification request component 725 a signature verification component 730, or any combination thereof. Each of these components may communicate, directly or indirectly, with one another (e.g., via one or more buses).

The identity verification request component 725 may be configured as or otherwise support a means for transmitting an identity verification request to a memory system. In some examples, the identity verification request component 725 may be configured as or otherwise support a means for receiving, from the memory system, a unique identifier for the memory system and a signature, where the signature is based at least in part on a private key associated with the memory system, and where the private key is based at least in part on a physical unclonable function for the memory system. The signature verification component 730 may be configured as or otherwise support a means for verifying the signature based at least in part on a public key corresponding to the private key associated with the memory system.

In some examples, to support verifying the signature based at least in part on the public key, the signature verification component 730 may be configured as or otherwise support a means for transmitting the unique identifier for the memory system and the signature to a certificate authority associated with the memory system. In some examples, to support verifying the signature based at least in part on the public key, the signature verification component 730 may be configured as or otherwise support a means for receiving an indication from the certificate authority of whether the unique identifier corresponds to the signature, the indication from the certificate authority based at least in part on the public key.

In some examples, to support verifying the signature based at least in part on the public key, the signature verification component 730 may be configured as or otherwise support a means for receiving, from a certificate authority associated with the memory system, a certificate endorsed by the certificate authority. In some examples, to support verifying the signature based at least in part on the public key, the signature verification component 730 may be configured as or otherwise support a means for determining, based at least in part on the certificate endorsed by the certificate authority, the public key associated with the memory system. In some examples, to support verifying the signature based at least in part on the public key, the signature verification component 730 may be configured as or otherwise support a means for verifying the signature using the public key associated with the memory system.

In some examples, the identity verification request component 725 may be configured as or otherwise support a means for generating the identity verification request based at least in part on a nonce, where the signature is based at least in part on the nonce being encrypted using the private key associated with the memory system.

In some examples, the identity verification request component 725 may be configured as or otherwise support a means for receiving an indication of the nonce from a certificate authority associated with the memory system.

In some examples, signature verification component 730 may be configured as or otherwise supports a means for receiving, from a certificate authority, a certificate signing requested based at least in part on verifying the signature.

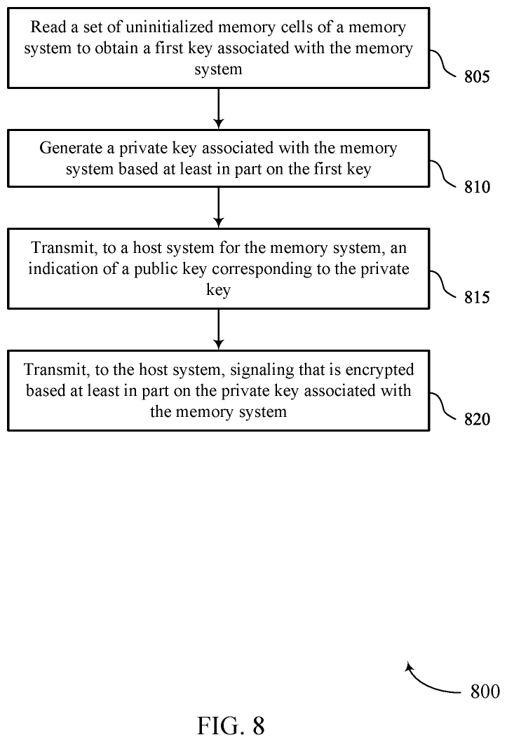

FIG. 8 shows a flowchart illustrating a method 800 that supports use of a physically unclonable function to generate a memory identifier in accordance with examples as disclosed herein. The operations of method 800 may be implemented by a memory system or its components as described herein. For example, the operations of method 800 may be performed by a memory system as described with reference to FIGS. 1 through 6. In some examples, a memory system may execute a set of instructions to control the functional elements of the device to perform the described functions. Additionally or alternatively, the memory system may perform aspects of the described functions using special-purpose hardware.

At 805, the method may include reading a set of uninitialized memory cells of a memory system to obtain a first key associated with the memory system. The operations of 805 may be performed in accordance with examples as disclosed herein. In some examples, aspects of the operations of 805 may be performed by a reading component 625 as described with reference to FIG. 6.

At 810, the method may include generating a private key associated with the memory system based at least in part on the first key. The operations of 810 may be performed in accordance with examples as disclosed herein. In some examples, aspects of the operations of 810 may be performed by a key generator 630 as described with reference to FIG. 6.

At 815, the method may include transmitting, to a host system for the memory system, an indication of a public key corresponding to the private key. The operations of 815 may be performed in accordance with examples as disclosed herein. In some examples, aspects of the operations of 815 may be performed by a key transmitter 635 as described with reference to FIG. 6.

At 820, the method may include transmitting, to the host system, signaling that is encrypted based at least in part on the private key associated with the memory system. The operations of 820 may be performed in accordance with examples as disclosed herein. In some examples, aspects of the operations of 820 may be performed by an encrypted signaling transmitter 640 as described with reference to FIG. 6.

In some examples, an apparatus as described herein may perform a method or methods, such as the method 800. The apparatus may include, features, circuitry, logic, means, or instructions (e.g., a non-transitory computer-readable medium storing instructions executable by a processor), or any combination thereof for performing the following aspects of the present disclosure:

Aspect 1: The apparatus, including features, circuitry, logic, means, or instructions, or any combination thereof for reading a set of uninitialized memory cells of a memory system to obtain a first key associated with the memory system; generating a private key associated with the memory system based at least in part on the first key; transmitting (e.g., to a host system for the memory system) an indication of a public key corresponding to the private key; and transmitting (e.g., to the host system) signaling that is encrypted based at least in part on the private key associated with the memory system.

Aspect 2: The apparatus of aspect 1 where operations, features, circuitry, logic, means, or instructions, or any combination thereof for reading the set of uninitialized memory cells to obtain the first key, includes operations, features, circuitry, logic, means, or instructions, or any combination thereof for sensing, for each memory cell of the set of uninitialized memory cells, a respective uninitialized state of the memory cell and determining, for each memory cell of the set of uninitialized memory cells, a respective logic value corresponding to the respective uninitialized state of the memory cell, where the first key is based at least in part on a set of logic values that includes the respective logic value for each memory cell of the set of uninitialized memory cells.

Aspect 3: The apparatus of aspect 2 where operations, features, circuitry, logic, means, or instructions, or any combination thereof for reading the set of uninitialized memory cells to obtain the first key, includes operations, features, circuitry, logic, means, or instructions, or any combination thereof for generating the first key based at least in part on a redundancy associated with the set of logic values, where the set of logic values includes a greater quantity of bits than the first key.

Aspect 4: The apparatus of any of aspects 2 through 3, where the respective uninitialized state that is sensed for a memory cell of the set of uninitialized memory cells is based at least in part on one or more physical characteristics of the memory cell.

Aspect 5: The apparatus of aspect 4, where the one or more physical characteristics of the memory cell are based at least in part on one or more variations in a fabrication process for the memory cell.

Aspect 6: The apparatus of any of aspects 2 through 5, where a set of uninitialized states for the set of uninitialized memory cells includes a physical unclonable function for the memory system, the set of uninitialized states including the respective uninitialized state for each memory cell of the set of uninitialized memory cells.

Aspect 7: The apparatus of any of aspects 1 through 6, further including operations, features, circuitry, logic, means, or instructions, or any combination thereof for generating a certificate associated with the memory system based at least in part on the public key and outputting an indication of the certificate (e.g., to a device external to the memory system).

Aspect 8: The apparatus of any of aspects 1 through 7, further including operations, features, circuitry, logic, means, or instructions, or any combination thereof for receiving (e.g., from the host system) an identity verification request and transmitting (e.g., to the host system), in response to the identity verification request, a unique identifier for the memory system and a signature based at least in part on the private key.

Aspect 9: The apparatus of any of aspects 1 through 8, further including operations, features, circuitry, logic, means, or instructions, or any combination thereof for generating the public key based at least in part on the private key.

Aspect 10: The apparatus of any of aspects 1 through 9, where the first key is a symmetric key.

Aspect 11: The apparatus of any of aspects 1 through 10, where the set of uninitialized memory cells includes a set of static random-access memory cells.

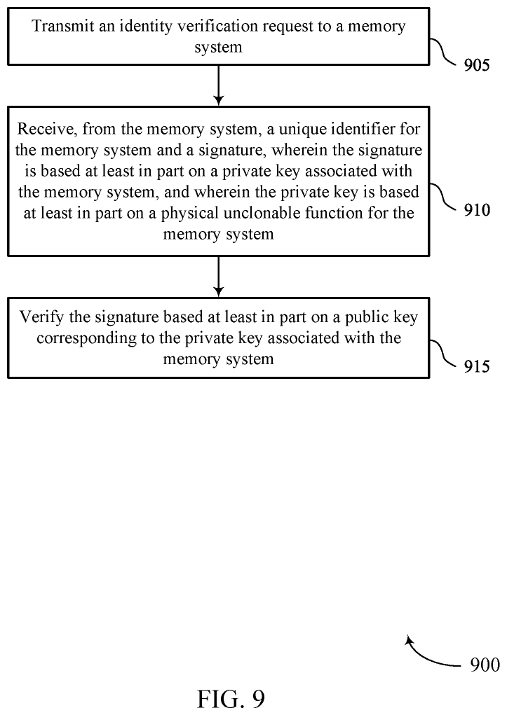

FIG. 9 shows a flowchart illustrating a method 900 that supports use of a physically unclonable function to generate a memory identifier in accordance with examples as disclosed herein. The operations of method 900 may be implemented by a host system or its components as described herein. For example, the operations of method 900 may be performed by a host system as described with reference to FIGS. 1 through 5 and 7. In some examples, a host system may execute a set of instructions to control the functional elements of the device to perform the described functions. Additionally or alternatively, the host system may perform aspects of the described functions using special-purpose hardware.

At 905, the method may include transmitting an identity verification request to a memory system. The operations of 905 may be performed in accordance with examples as disclosed herein. In some examples, aspects of the operations of 905 may be performed by an identity verification request component 725 as described with reference to FIG. 7.

At 910, the method may include receiving, from the memory system, a unique identifier for the memory system and a signature, where the signature is based at least in part on a private key associated with the memory system, and where the private key is based at least in part on a physical unclonable function for the memory system. The operations of 910 may be performed in accordance with examples as disclosed herein. In some examples, aspects of the operations of 910 may be performed by an identity verification request component 725 as described with reference to FIG. 7.

At 915, the method may include verifying the signature based at least in part on a public key corresponding to the private key associated with the memory system. The operations of 915 may be performed in accordance with examples as disclosed herein. In some examples, aspects of the operations of 915 may be performed by a signature verification component 730 as described with reference to FIG. 7.

In some examples, an apparatus as described herein may perform a method or methods, such as the method 900. The apparatus may include, features, circuitry, logic, means, or instructions (e.g., a non-transitory computer-readable medium storing instructions executable by a processor), or any combination thereof for performing the following aspects of the present disclosure:

Aspect 12: The apparatus, including features, circuitry, logic, means, or instructions, or any combination thereof for transmitting an identity verification request (e.g., to a memory system); receiving (e.g., from the memory system) a unique identifier for the memory system and a signature, where the signature is based at least in part on a private key associated with the memory system, and where the private key is based at least in part on a physical unclonable function for the memory system; and verifying the signature based at least in part on a public key corresponding to the private key associated with the memory system.

Aspect 13: The apparatus of aspect 12 where operations, features, circuitry, logic, means, or instructions, or any combination thereof for verifying the signature based at least in part on the public key, includes operations, features, circuitry, logic, means, or instructions, or any combination thereof for transmitting the unique identifier for the memory system and the signature to a certificate authority associated with the memory system and receiving an indication from the certificate authority of whether the unique identifier corresponds to the signature, the indication from the certificate authority based at least in part on the public key.

Aspect 14: The apparatus of any of aspects 12 through 13 where operations, features, circuitry, logic, means, or instructions, or any combination thereof for verifying the signature based at least in part on the public key, includes operations, features, circuitry, logic, means, or instructions, or any combination thereof for receiving, from a certificate authority associated with the memory system, a certificate endorsed by the certificate authority; determining, based at least in part on the certificate endorsed by the certificate authority, the public key associated with the memory system; and verifying the signature using the public key associated with the memory system.

Aspect 15: The apparatus of any of aspects 12 through 14, further including operations, features, circuitry, logic, means, or instructions, or any combination thereof for generating the identity verification request based at least in part on a nonce, where the signature is based at least in part on the nonce being encrypted using the private key associated with the memory system.

Aspect 16: The apparatus of aspect 15, further including operations, features, circuitry, logic, means, or instructions, or any combination thereof for receiving an indication of the nonce from a certificate authority associated with the memory system.

Aspect 17: The apparatus of aspect 15, further including operations, features, circuitry, logic, means, or instructions, or any combination thereof for receiving (e.g., from a certificate authority) a certificate signing request based at least in part on verifying the signature.

It should be noted that the methods described above describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The term “layer” or “level” used herein refers to a stratum or sheet of a geometrical structure (e.g., relative to a substrate). Each layer or level may have three dimensions (e.g., height, width, and depth) and may cover at least a portion of a surface. For example, a layer or level may be a three dimensional structure where two dimensions are greater than a third, e.g., a thin-film. Layers or levels may include different elements, components, or materials. In some examples, one layer or level may be composed of two or more sublayers or sublevels.

As used herein, the term “substantially” means that the modified characteristic (e.g., a verb or adjective modified by the term substantially) need not be absolute but is close enough to achieve the advantages of the characteristic.

As used herein, the term “electrode” may refer to an electrical conductor, and in some examples, may be employed as an electrical contact to a memory cell or other component of a memory array. An electrode may include a trace, wire, conductive line, conductive layer, or the like that provides a conductive path between elements or components of a memory array.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally or alternatively (e.g., in an alternative example) be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to providing an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a memory system; and
a controller for the memory system and configured to cause the apparatus to:
read a set of uninitialized memory cells of the memory system to obtain a first key associated with the memory system;
generate a private key associated with the memory system based at least in part on the first key;
transmit an indication of a public key corresponding to the private key; and
transmit signaling that is encrypted based at least in part on the private key associated with the memory system.

2. The apparatus of claim 1, wherein, to read the set of uninitialized memory cells to obtain the first key, the controller is configured to cause the apparatus to:
sensing, for each memory cell of the set of uninitialized memory cells, a respective uninitialized state of the memory cell; and
determine, for each memory cell of the set of uninitialized memory cells, a respective logic value corresponding to the respective uninitialized state of the memory cell, wherein the first key is based at least in part on a set of logic values that comprises the respective logic value for each memory cell of the set of uninitialized memory cells.

3. The apparatus of claim 2, wherein, to read the set of uninitialized memory cells to obtain the first key, the controller is configured to cause the apparatus to:
generate the first key based at least in part on a redundancy associated with the set of logic values, wherein the set of logic values comprises a greater quantity of bits than the first key.

4. The apparatus of claim 2, wherein the respective uninitialized state that is sensed for a memory cell of the set of uninitialized memory cells is based at least in part on one or more physical characteristics of the memory cell.

5. The apparatus of claim 4, wherein the one or more physical characteristics of the memory cell are based at least in part on one or more variations in a fabrication process for the memory cell.

6. The apparatus of claim 2, wherein a set of uninitialized states for the set of uninitialized memory cells comprises a physical unclonable function for the memory system, the set of uninitialized states comprising the respective uninitialized state for each memory cell of the set of uninitialized memory cells.

7. The apparatus of claim 1, wherein the controller is further configured to cause the apparatus to:
generate a certificate associated with the memory system based at least in part on the public key; and
output an indication of the certificate.

8. The apparatus of claim 1, wherein the controller is further configured to cause the apparatus to:
receive an identity verification request; and
transmit, in response to the identity verification request, a unique identifier for the memory system and a signature based at least in part on the private key.

9. The apparatus of claim 1, wherein the controller is further configured to cause the apparatus to:
generate the public key based at least in part on the private key.

10. The apparatus of claim 1, wherein the first key comprises a symmetric key.

11. The apparatus of claim 1, wherein the set of uninitialized memory cells comprises a set of static random-access memory cells.

12. An apparatus, comprising:
a controller configured to couple with a memory system, wherein the controller is configured to cause the apparatus to:
transmit an identity verification request;
receive a unique identifier for the memory system and a signature, wherein the signature is based at least in part on a private key associated with the memory system, and wherein the private key is based at least in part on a physical unclonable function for the memory system; and
verify the signature based at least in part on a public key corresponding to the private key associated with the memory system.

13. The apparatus of claim 12, wherein, to verify the signature based at least in part on the public key, the controller is configured to cause the apparatus to:
transmit the unique identifier for the memory system and the signature to a certificate authority associated with the memory system; and
receive an indication from the certificate authority of whether the unique identifier corresponds to the signature, the indication from the certificate authority based at least in part on the public key.

14. The apparatus of claim 12, wherein, to verify the signature based at least in part on the public key, the controller is configured to cause the apparatus to:
receive a certificate endorsed by a certificate authority associated with the memory system;
determine, based at least in part on the certificate endorsed by the certificate authority, the public key associated with the memory system; and
verify the signature using the public key associated with the memory system.

15. The apparatus of claim 12, wherein the controller is further configured to cause the apparatus to:
generate the identity verification request based at least in part on a nonce, wherein the signature is based at least in part on the nonce being encrypted using the private key associated with the memory system.

16. The apparatus of claim 15, wherein the controller is further configured to cause the apparatus to:
receive an indication of the nonce from a certificate authority associated with the memory system.

17. The apparatus of claim 15, wherein the controller is further configured to cause the apparatus to:
receive a certificate signing request based at least in part on verifying the signature.

18. A non-transitory computer-readable medium storing code, the code comprising instructions executable by a processor to:
read a set of uninitialized memory cells of a memory system to obtain a first key associated with the memory system;
generate a private key associated with the memory system based at least in part on the first key;
transmit an indication of a public key corresponding to the private key; and
transmit signaling that is encrypted based at least in part on the private key associated with the memory system.

19. The non-transitory computer-readable medium of claim 18, wherein the instructions to read the set of uninitialized memory cells to obtain the first key are executable by the processor to:
sensing, for each memory cell of the set of uninitialized memory cells, a respective uninitialized state of the memory cell; and
determine, for each memory cell of the set of uninitialized memory cells, a respective logic value corresponding to the respective uninitialized state of the memory cell, wherein the first key is based at least in part on a set of logic values that comprises the respective logic value for each memory cell of the set of uninitialized memory cells.

20. The non-transitory computer-readable medium of claim 19, wherein the instructions to read the set of uninitialized memory cells to obtain the first key are further executable by the processor to:
generate the first key based at least in part on a redundancy associated with the set of logic values, wherein the set of logic values comprises a greater quantity of bits than the first key.

21. The non-transitory computer-readable medium of claim 19, wherein the respective uninitialized state that is sensed for a memory cell of the set of uninitialized memory cells is based at least in part on one or more physical characteristics of the memory cell.

22. The non-transitory computer-readable medium of claim 21, wherein the one or more physical characteristics of the memory cell are based at least in part on one or more variations in a fabrication process for the memory cell.

23. The non-transitory computer-readable medium of claim 19, wherein a set of uninitialized states for the set of uninitialized memory cells comprises a physical unclonable function for the memory system, the set of uninitialized states comprising the respective uninitialized state for each memory cell of the set of uninitialized memory cells.

24. The non-transitory computer-readable medium of claim 18, wherein the instructions are further executable by the processor to:
generate a certificate associated with the memory system based at least in part on the public key; and
output an indication of the certificate.

25. The non-transitory computer-readable medium of claim 18, wherein the instructions are further executable by the processor to:
receive an identity verification request; and
transmit, in response to the identity verification request, a unique identifier for the memory system and a signature based at least in part on the private key.
